(19) United States
(12) Patent Application Publication
(10) Pub. No.: US 2019/0313177 A1
(43) Pub. Date: Oct. 10, 2019

(54) WIRELESS EARPHONE

(71) Applicants: Wei-Jei Shiang, Taipei (TW); Hui-Erh Yu, Taipei (TW); Tzu-Han Wei, Taipei (TW)

(72) Inventor: Wei-Jei Shiang, Taipei (TW)

(21) Appl. No.: 16/185,731

(22) Filed: Nov. 9, 2018

(30) Foreign Application Priority Data
Apr. 10, 2018 (TW) 107204618
Jun. 28, 2018 (TW) 107122275

(51) Int. Cl. H04R 1/10

(52) U.S. Cl. CPC H04R 1/1041; H04R 1/1016; H04R 2420/07; H04R 1/1025; H04R 1/1033

(57) ABSTRACT

A wireless earphone comprises a first earphone portion and a second earphone portion. The first earphone portion includes a first loudspeaker, a first connecting wire connected to the first loudspeaker, and a first connector disposed at one end of the first connecting wire. The second earphone portion includes a second loudspeaker, a second connecting wire connected to the second loudspeaker, an earphone control module disposed on the second connecting wire, and a second connector disposed at one end of the second connecting wire. The second connector has a first connected state, in which the second connector is connected to the first connector such that the earphone control module sends signals to the first earphone portion, and a first separated state, in which the second connector is separated from the first connector and connected to an external device to acquire electric power for charging the earphone control module.

### FIELD OF THE INVENTION

The present invention is related to a wireless earphone, particularly to a structurally detachable wireless earphone with some components used as a charging cable.

### BACKGROUND OF THE INVENTION

As wireless earphones develop, there have been industries launching structurally detachable wireless earphones, such as those disclosed in the Patents No. TW M510579, TW M550006, CN 204948299, CN 206117951, CN 206402402, CN 206575571, TW M558505, TW M546642, TW M507129, CN 206775697, CN 206743492, CN 206686338, CN 206498514, CN 206302535, CN206212240, CN 206136196, CN 205249449, CN 204948300 and CN 104023288.

Accordingly, although the detachable structure of earphone is proposed in the aforementioned patents, additional charging cables are required for charging Bluetooth earphones disclosed in the aforementioned patents when the Bluetooth earphones reach a low battery level.

### SUMMARY OF THE INVENTION

The main object of the present invention is to solve a problem, which the additional charging cable is still required for charging the conventional Bluetooth earphone.

For achieving the above object, the present invention provides a wireless earphone including a first earphone portion and a second earphone portion. The first earphone portion includes a first loudspeaker, a first connecting wire connected to the first loudspeaker, and a first connector disposed at one end of the first connecting wire, where is not connected to the first loudspeaker. The second earphone portion includes a second loudspeaker, a second connecting wire connected to the second loudspeaker, an earphone control module disposed on the second connecting wire, and a second connector disposed at one end of the second connecting wire, where is not connected to the second loudspeaker. The earphone control module includes a battery. The second connector has a first connected state, in which the second connector is connected to the first connector such that the earphone control module sends signals to the first earphone portion via the first connector, and a first separated state, in which the second connector is separated from the first connector and then connected to a third connector of an external device to acquire electric power for charging the earphone control module.

In one embodiment, each of the first connector and the second connector is a Universal Serial Bus.

In one embodiment, the earphone control module includes a memory element, and the second connector is able to transmit data of the external device to the earphone control module for storing the data in the memory element in the first separated state.

In one embodiment, the earphone control module includes a management module connected to the battery and generating a charging indicating signal when the battery is charged and a charging indicating lamp connected to the management module to receive the charging indicating signal for displaying.

The present invention also provides another wireless earphone including a first earphone portion and a second earphone portion. The first earphone portion includes a first loudspeaker, a first connecting wire connected to the first loudspeaker, an earphone controller disposed on the first connecting wire, and a first connector disposed at one end of the first connecting wire, where is not connected to the first loudspeaker. The second earphone portion includes a second loudspeaker, a second connecting wire connected to the second loudspeaker, a power supply module disposed on the second connecting wire, and a second connector connected to the second connecting wire. The second connector includes a first connected state, in which the second connector is connected to the first connector such that electric power stored in the power supply module is outputted to the first earphone portion via the first connector, and a first separated state, in which the second connector is separated from the first connector and then connected to a third connector of an external device to acquire electric power for charging the power supply module.

In one embodiment, each of the first connector and the second connector is a Universal Serial Bus.

In one embodiment, the second connecting wire includes a first line connecting the second loudspeaker to the power supply module and a second line connecting the power supply module to the second connector, the power supply module including a fourth connector connected to the second line, the second connecting wire including a fifth connector disposed at the second line, the fifth connector having a second connected state, in which the fifth connector is connected to the fourth connector to output electric power stored in the power supply module to the second connector, and a second separated state, in which the fifth connector is separated from the fourth connector and then connected to the external device to transmit from the external device data to the second connector.

In one embodiment, the second earphone portion includes a case body for accommodating the fifth connector, the case body including a first chamber for accommodating the fifth connector and a second chamber separated from the first chamber for accommodating an adaptor.

In one embodiment, the power supply module includes a battery, an electric power management unit connected to the battery and generating a charging indicating signal when the battery is charged, and a charging indicating lamp connected to the electric power management unit to receive the charging indicating signal for displaying.

As compared to the prior art, there are features achieved via what is disclosed in the foregoing of the present invention as follows. The first earphone portion is able to be disconnected from the second earphone portion of the present invention according to implementation requirement. A part of the structure of the second earphone portion including the battery is able to use as a charging cable for charging the battery. Namely, the wireless earphone of the present invention includes a charging cable by itself. In addition, it is unnecessary for the wireless earphone of the present invention to connect with the additional charging cable during charging, such that there is no need for a dedicated connecting port provided with respect to the above-mentioned charging cable on the wireless earphone, without any unexpected and destructed hole on the whole appearance, so as to enhance the feeling of design of the wireless earphone significantly. Furthermore, the wireless earphone of the present invention is used unceasingly when the life of the battery of the wireless earphone is ended through the replacement of the second earphone portion including the battery due to the detachable structure of the wireless earphone. Additionally, it is also possible for the user to regard another second earphone portion as a spare battery, in such a way that only the replacement of the second earphone portion is required when the wireless earphone reaches a low battery level.

### BRIEF DESCRIPTION OF THE DRAWINGS

FIG. 1 is a structural diagram of one embodiment of the present invention.

FIG. 2 is a structural diagram of a second connector in a first separated state according to one embodiment of the present invention.

FIG. 3 is an implementation diagram of the second connector in the first separated state according to one embodiment of the present invention.

FIG. 4 is a block diagram of one embodiment of the present invention.

FIG. 5 is a structural diagram of another embodiment of the present invention.

FIG. 6 is a structural diagram of a second connector in a first separated state according to another embodiment of the present invention.

FIG. 7 is a structural diagram of a second earphone portion according to another embodiment of the present invention.

FIG. 8 is a structural diagram of a fifth connector in a second separated state according to another embodiment of the present invention.

FIG. 9 is a partial structural diagram of another embodiment of the present invention.

FIG. 10 is a block diagram of another embodiment of the present invention.

### DETAILED DESCRIPTION OF THE PREFERRED EMBODIMENTS

The detailed description and technical content of the present invention will now be described, in conjunction with drawings, as follows.

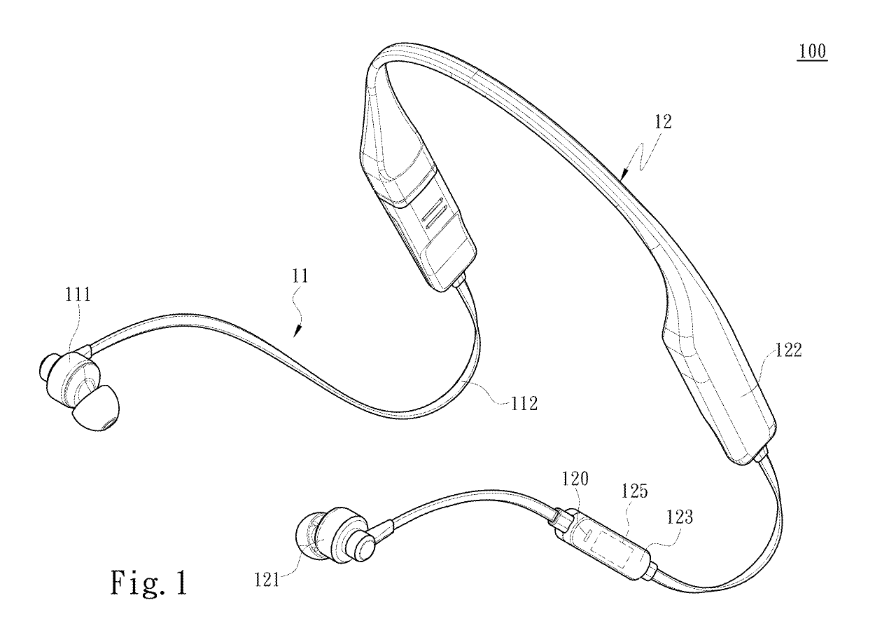

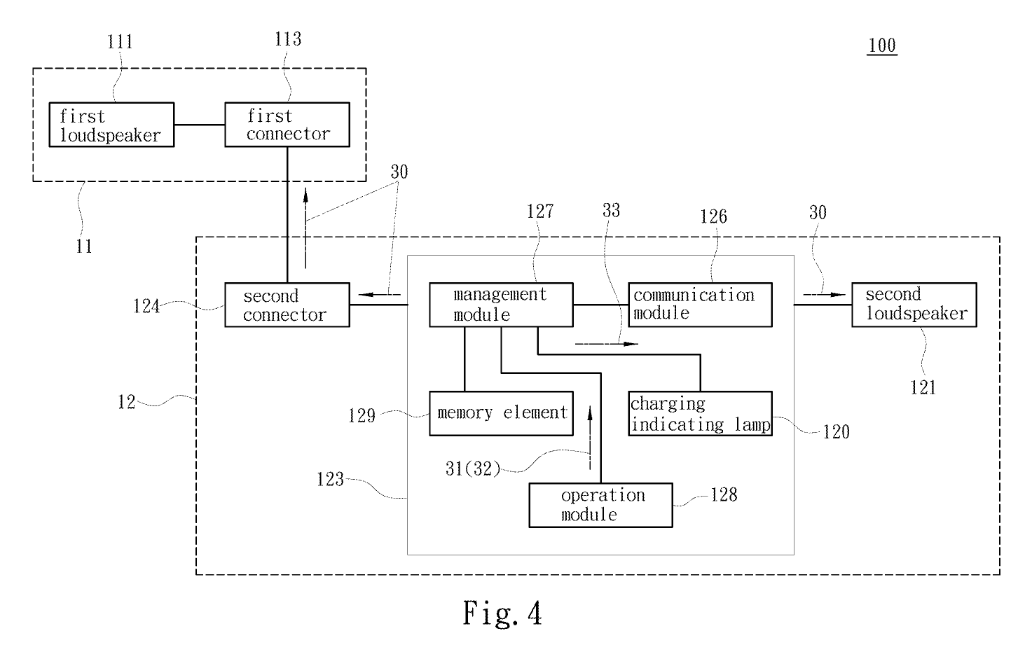

Referring to FIGS. 1 and 4, the present invention provides a wireless earphone 100. Although a headphone is taken as an example of the wireless earphone 100 in the figures of the present invention, the wireless earphone 100 is not limited thereto.

Next, the wireless earphone 100 includes a first earphone portion 11 and a second earphone portion 12. The first earphone portion 11 includes a first loudspeaker 111, a first connecting wire 112 connected to the first loudspeaker 111, and a first connector 113 disposed at one end of the first connecting wire 112, where is not connected to the first loudspeaker 111. On the other hand, the second earphone portion 12 includes a second loudspeaker 121, a second connecting wire 122 connected to the second loudspeaker 121, an earphone control module 123 provided on the second connecting wire 122, and a second connector 124 disposed at one end of the second connecting wire 122, where is not connected to the second loudspeaker 121. Further, each of the first connector 113 and the second connector 124 is a Universal Serial Bus (USB). The first connector 113 and the second connector 124 have the same USB specification. Additionally, if the first connector 113 is a socket outlet according to the USB specification, then the second connector 124 is a socket according to the same USB specification. That is, the first connector 113 is able to be joined to the second connector 124. Data transmission and electric power delivery are performed between the second connector 124 and the first connector 113 after joined.

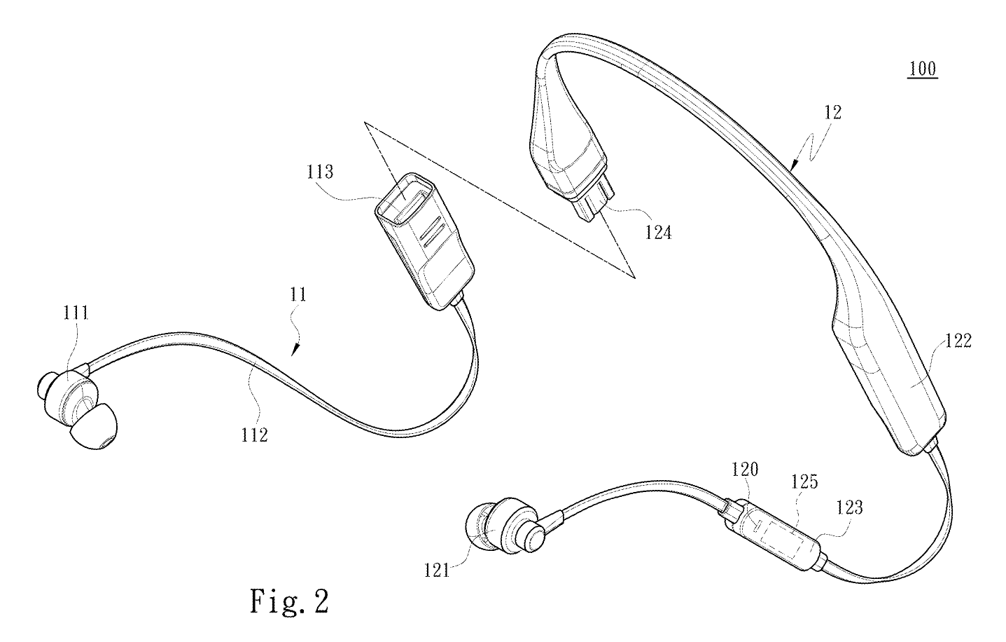

Referring to FIGS. 2 and 4 together, the earphone control module 123 contains a battery 125 therein. The battery 125 is not a primary battery, but is able to be charged and recharged repeatedly. In addition, the earphone control module 123 is further provided with a communication module 126, a management module 127 connected to the battery 125 and the communication module 126, and an operation module 128 connected to the management module 127 and disposed on an exterior of the earphone control module 123. The communication module 126 is communicated with a playback device on the basis of a wireless communication protocol, so as to receive a sound data 30 or other firmware data sent from the playback device. In this case, the wireless communication protocol is a Bluetooth protocol or other near-field communication protocols, and the playback device is a computer, a mobile phone, a tablet and so on. Furthermore, the management module 127 receives the sound data 30 from the communication module 126, and sends the sound data 30 to the first loudspeaker 111 and the second loudspeaker 121, so as to enable the first loudspeaker 111 and the second loudspeaker 121 to sound. Further, the management module 127 is implemented as a micro-controller. The management module 127 is set to include multiple control modes, each of the control modes is carried out according to an operation signal 31 or a combined operation signal 32 received by the management module 127 from the operation module 128, and each of the control modes corresponds to the different operation signal 31 or combined operation signal 32.

Referring to FIGS. 1, 2 and 3 again, the second connector 124 of the present invention includes a first connected state, in which the second connector 124 is connected to the first connector 113 such that the earphone control module 123 is able to send signals to the first earphone portion 11 via the first connector 113, and a first separated state, in which the second connector 124 is separated from the first connector 113 and then joined to a third connector 401 provided by an external device 40 so as to acquire electric power for charging the earphone control module 123. Specifically, when the wireless earphone 100 of the present invention is in a normal operation state without charging, the second connector 124 is in the first connected state, as illustrated in FIG. 1. In this state, the earphone control module 123 is able to transmit the sound data 30 and the electric power to the first connector 113 via the second connector 124 to operate the first earphone portion 11. Furthermore, the present invention provides a user to separate the first connector 113 from the second connector 124, depending upon a battery status of the earphone control module 123, such that the second connector 124 is in the first separated state, as illustrated in FIG. 2. In this state, the first earphone portion 11 and the second earphone portion 12 of the wireless earphone 100 are in a separated state. Therefore, the second connector 124 is able to be connected to the third connector 401. The external device 40 including the third connector 401 is a computer, a charger, and a power bank. After the second connector 124 and the third connector 401 are connected, the electric power for charging the battery 125 is acquired from the third connector 401 by the wireless earphone 100 for starting to charge the battery 125. After the battery 125 charging is completed, the user is able to separate the third connector 401 from the second connector 124 to reset the second connector 124 to the first connected state and continuously use the wireless earphone 100. Therefore, the design of the earphone control module 123 is simplified due to non-necessity of the earphone control module 123 further including an additional jack for connecting to the external device 40. Besides, an additional wire acquired for charging is unnecessary for the user according to the design of the present invention such that the trouble of carrying the additional wire for the user is eliminated. Furthermore, the wireless earphone 100 is used unceasingly provided that the battery 125 of the second earphone portion 12 is replaced when the life of the battery 125 of the wireless earphone 100 is ended due to the detachable structure of the wireless earphone 100 such that a problem derived from incapability of replacing battery in the conventional wireless earphone is solved specifically. Additionally, the wireless earphone 100 is also used unceasingly provided that the second earphone portion 12 is replaced when battery level of the battery 125 is low so that another second earphone portion is served as a spare battery.

In one embodiment, referring to FIG. 4 again, the earphone control module 123 includes a memory element 129. Moreover, in this embodiment of the present invention, the second connector 124 is able to receive data receiving the electric power for charging the battery 125, and transmitting the data to the earphone control module 123 in the first separated state, such that the data is stored in the memory element 129. To be more precise, the data of the external device 40 is transmitted to the earphone control module 123 and then stored in the memory element 129. Besides, the earphone control module 123 is further provided for the external device 40 to be read in the first separated state of the second connector 124. In another embodiment, the earphone control module 123 includes a charging indicating lamp 120 generated light with different colors according to a received charging indicating signal 33. Additionally, the above-mentioned charging indicating signal 33 is sent from the management module 127, and the charging indicating signal 33 is generated by the management module 127 when the battery 125 is charged. The charging indicating signal 33 includes a bit for controlling the colors of light of the charging indicating lamp 120.

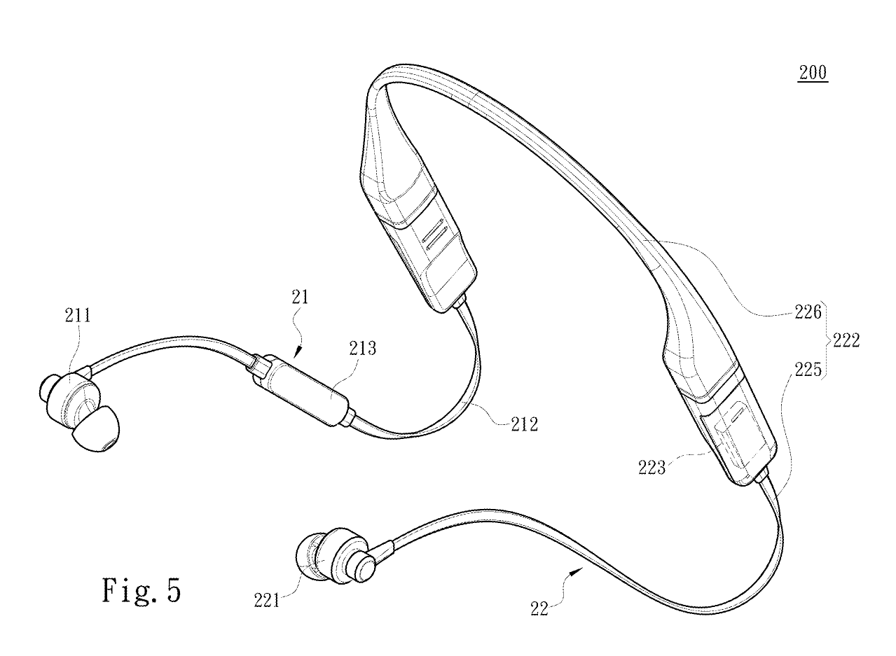

The wireless earphone 100 is explained as providing the battery 125 inside the earphone control module 123 in the above embodiment, but not limited to providing the battery 125 inside the earphone control module 123. Another embodiment is further explained below. In this context, the former and latter embodiments are differentiated by different numerals thereby for assisting in understanding. Referring to FIGS. 5, 6, 7, 8, 9 and 10, the wireless earphone 200 includes a first earphone portion 21 and a second earphone portion 22. The first earphone portion 21 includes a first loudspeaker 211, a first connecting wire 212 connected to the first loudspeaker 211, an earphone controller 213 disposed on the first connecting wire 212, and a first connector 214 disposed at one end of the first connecting wire 212, where is not connected to the first loudspeaker 211. On the other hand, the second earphone portion 12 includes a second loudspeaker 221, a second connecting wire 222 connected to the second loudspeaker 221, a power supply module 223 disposed on the second connecting wire 222, and a second connector 224 connected to the second connecting wire 222. Further, each of the first connector 214 and the second connector 224 is a Universal Serial Bus (USB) and specifications of both of them are the same.

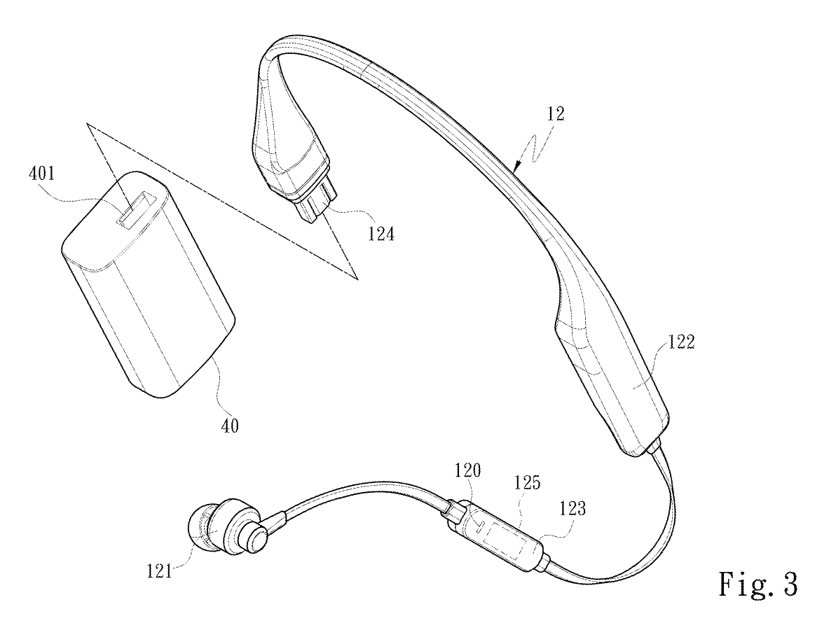

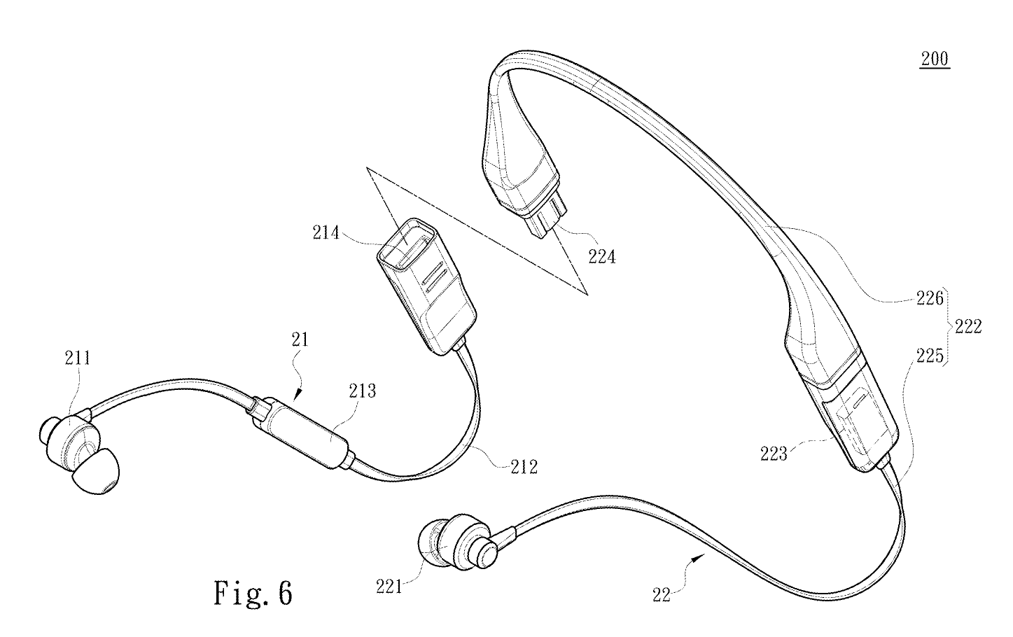

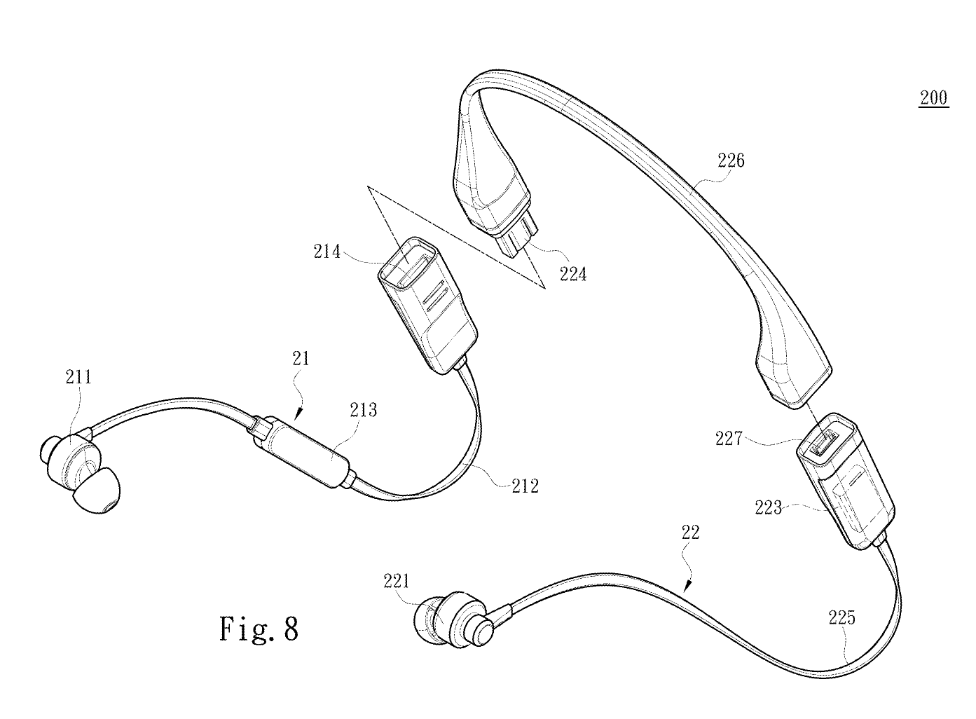

Next, the second connector 224 of this embodiment similarly includes a first connected state and a second connected state. Referring to FIG. 5, the second connector 224 and the first connector 214 are connected together in the first connected state, such that electric power stored in the power supply module 223 is outputted to the first earphone portion 21 via the first connector 214. Further, the first connecting wire 212 and the second connecting wire 222 are communicated with each other equivalently, after the first connector 214 and the second connector 224 are joined to each other, such that the earphone controller 213 acquires the electric power required for operation from the power supply module 223, and the earphone controller 213 sends the sound data 30 to the first loudspeaker 211 and the second loudspeaker 221 so as to enable the first loudspeaker 211 and the second loudspeaker 221 to sound. On the other hand, the first separated state is directed to separation of the first connector 214 from the second connector 224, as illustrated in FIGS. 6 and 8. The second connector 224 is connected to the third connector 401 of the external device 40, when the second connector 224 is in the first separated state to acquire the electric power for charging the power supply module 223, as shown in FIG. 3. As such, a part of the second connector 224 and the second connecting wire 222 of the present invention is used as a charging cable, namely, the wireless earphone 200 of the present invention is provided with the charging cable by itself. Thus, there is no need for the user to use an additional charging cable when charging the wireless earphone 200.

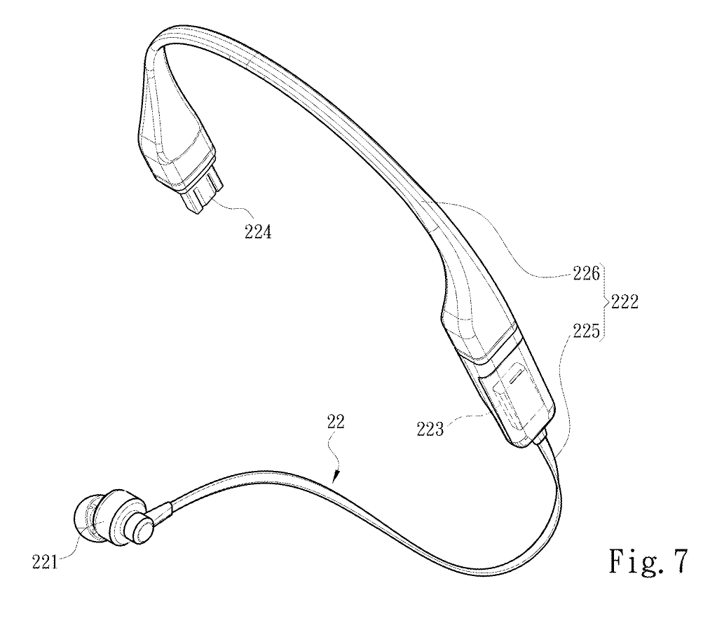

Referring to FIGS. 5, 6, 7, 8 and 9, in one embodiment, the second connecting wire 222 includes a first line 225 connected the second loudspeaker 221 to the power supply module 223, and a second line 226 connected the power supply module 223 to the second connector 224. The power supply module 223 includes a fourth connector 227 connected to the second line 226. The second connecting wire 222 includes a fifth connector 228 disposed at the second line 226, and the fifth connector 228 has a second connected state and a second separated state. Additionally, when the fifth connector 228 and the fourth connector 227 are connected, the fifth connector 228 is in the second connected state as shown in FIGS. 6 and 7. Therefore, electric power stored in the power supply module 223 is outputted to the second connector 224 via the fifth connector 228, and the fifth connector 228 also receives electric power delivered from the second connector 224. On the other hand, the fifth connector 228 is in the second separated state, when the fifth connector 228 and the fourth connector 227 are separated from each other. As illustrated in FIG. 8, when the second connector 224 is in the first separated state, the second line 226 of the second connecting wire 222 is used as a wire provided for connecting to other devices. Furthermore, when the second connector 224 is in the first connected state, the fifth connector 228 is able to connect to the external device 40 to receive data sent from the external device 40 and then transmit the data to the second connector 224. That is, the earphone controller 213 is able to receive the data for performing data update.

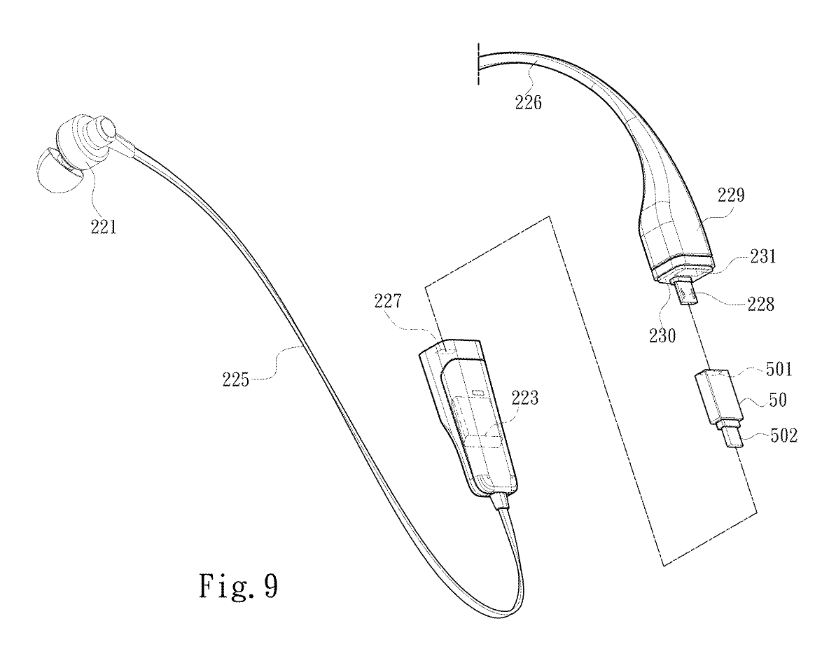

Referring to FIG. 9, in one embodiment, the second earphone portion 22 includes a case body 229 for accommodating the fifth connector 228, the case body 229 includes a first chamber 230 for accommodating the fifth connector 228 and a second chamber 231 separated from the first chamber 230 for accommodating an adaptor 50. The adaptor 50 includes a first connecting part 501 connected the fifth connector 228, a second connecting part 502 with a different specification from the first connecting part 501 and connected an external connecting part. Thereby, the fifth connector 228 is able to be connected to a socket which has a specification different from the fifth connector 228 via the adaptor 50.

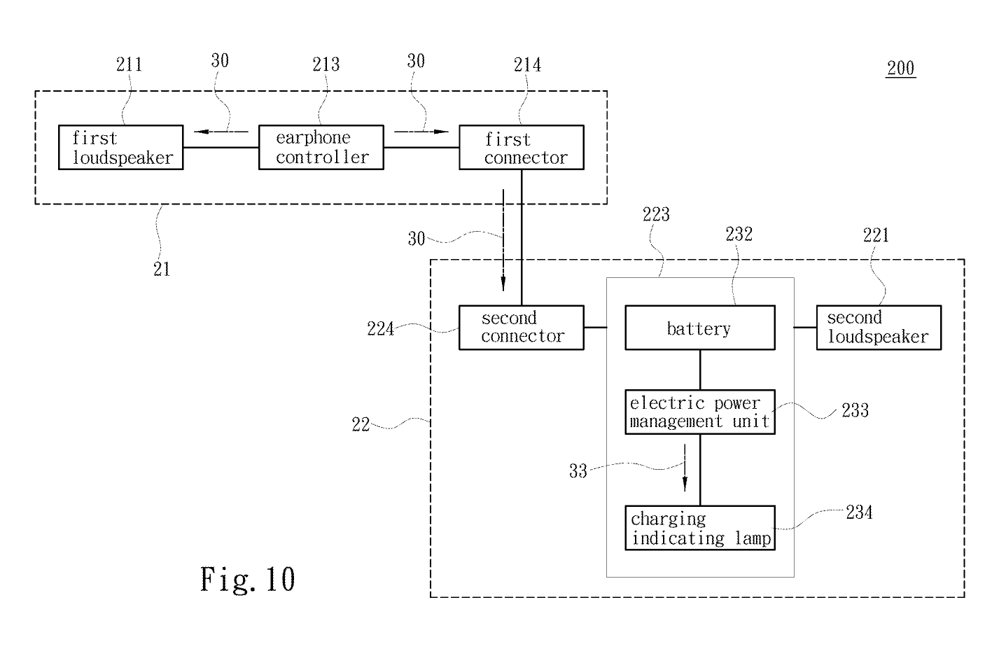

Referring to FIG. 10, in one embodiment, the power supply module 223 further includes a battery 232, an electric power management unit 233 connected to the battery 232 and generating the charging indicating signal 33 when the battery 232 is charged, and a charging indicating lamp 234 connected to the electric power management unit 233 and receiving the charging indicating signal 33 for displaying to assist in informing the user of a status of the power supply module 223 when the power supply module 223 is separated from the earphone controller 213

What is claimed is:

1. A wireless earphone comprising:
a first earphone portion including a first loudspeaker, a first connecting wire connected to said first loudspeaker, and a first connector disposed at one end of said first connecting wire, where is not connected to said first loudspeaker; and
a second earphone portion including a second loudspeaker, a second connecting wire connected to said second loudspeaker, an earphone control module disposed on said second connecting wire, and a second connector disposed at one end of said second connecting wire, where is not connected to said second loudspeaker, said earphone control module including a battery, said second connector having a first connected state, in which said second connector is connected to said first connector such that said earphone control module is able to send signals to said first earphone portion via said first connector, and said second connector having a first separated state, in which said second connector is separated from said first connector and then connected to a third connector of an external device to acquire electric power for charging said earphone control module.

2. The wireless earphone according to claim 1, wherein each of said first connector and said second connector is a Universal Serial Bus.

3. The wireless earphone according to claim 2, wherein said earphone control module includes a memory element, and said second connector is able to transmit data of said external device to said earphone control module for storing the data in said memory element in said first separated state.

4. The wireless earphone according to claim 2, wherein said earphone control module includes a management module connected to said battery and generating a charging indicating signal when said battery is charged and a charging indicating lamp connected to said management module to receive said charging indicating signal for displaying.

5. A wireless earphone comprising:
a first earphone portion including a first loudspeaker, a first connecting wire connected to said first loudspeaker, an earphone controller disposed on said first connecting wire, and a first connector disposed at one end of said first connecting wire, where is not connected to said first loudspeaker; and
a second earphone portion including a second loudspeaker, a second connecting wire connected to said second loudspeaker, a power supply module disposed on said second connecting wire, and a second connector connected to said second connecting wire, said second connector having a first connected state, in which said second connector is connected to said first connector such that electric power stored in said power supply module is outputted to said first earphone portion via said first connector, and said second connector having a first separated state, in which said second connector is separated from said first connector and then connected to a third connector of an external device to acquire electric power for charging said power supply module.

6. The wireless earphone according to claim 5, wherein each of said first connector and said second connector is a Universal Serial Bus.

7. The wireless earphone according to claim 5, wherein said second connecting wire includes a first line connecting said second loudspeaker to said power supply module and a second line connecting said power supply module to said second connector, said power supply module including a fourth connector connected to said second line, said second connecting wire including a fifth connector disposed at said second line, said fifth connector having a second connected state, in which said fifth connector is connected to said fourth connector to output electric power stored in said power supply module to said second connector, and said fifth connector having a second separated state, in which said fifth connector is separated from said fourth connector and then connected to said external device to transmit data from said external device to said second connector.

8. The wireless earphone according to claim 7, wherein said second earphone portion includes a case body for accommodating said fifth connector, the case body including a first chamber for accommodating said fifth connector and a second chamber separated from said first chamber for accommodating an adaptor.

9. The wireless earphone according to claim 7, wherein said power supply module includes a battery, an electric power management unit connected to said battery and generating a charging indicating signal when said battery is charged, and a charging indicating lamp connected to said electric power management unit and receives said charging indicating signal for displaying.
